(19) United States
(12) Patent Application Publication
(10) Pub. No.: US 2009/0076955 A1
(43) Pub. Date: Mar. 19, 2009

(54) Electronic device repair kits and methods of use

(75) Inventors: Ronald S. Hoy, Merrimack, NH (US); Jeffrey S. Harrison, Merrimack, NH (US); Charles Kouyoumijian, Boston, MA (US); Glen Kashgegian, Belmont, MA (US)

Correspondence Address: BOWDITCH & DEWEY, LLP, 311 MAIN STREET, P.O. BOX 15156, WORCESTER, MA, 01615-0156, US

(73) Assignee: Blue Raven Technology, Inc., Wilmington, MA (US)

(21) Appl. No.: 12/231,495

(22) Filed: Sep. 2, 2008

Related U.S. Application Data
(60) Provisional application No. 60/969,630, filed on Sep. 2, 2007.
(60) Provisional application No. 61/013,390, filed on Dec. 13, 2007.

(51) Int. Cl. G06Q 30/00; G06Q 20/00

(52) U.S. Cl. 705/40; 235/375; 705/1

(57) ABSTRACT

A method of obtaining a repair for an electronic device from a repair vendor, and an electronic device repair kit for use with the method. Use of the method and kits provides consumers with the ability to purchase repair services for a selected electronic device for a predetermined flat fee and to have the repaired device returned in a relatively short time-frame.

### RELATED CASES

This application claims the benefit of U.S. Provisional Patent Application Nos. 60/969,630, which was filed on Sep. 2, 2007, and 61/013,390, which was filed on Dec. 13, 2007, both of which are incorporated herein by reference in their entirety.

### TECHNICAL FIELD

The present disclosure relates to methods of obtaining repairs for electronic devices from a repair vendor, and repair kits for use with the method.

### BACKGROUND

Most retail stores that sell electronic devices are “resellers” of the electronic devices, and do not provide a warranty for the devices. Most electronic devices are covered by an original manufacturer's warranty that begins at the time of purchase, and that may be limited in coverage, duration, or both.

As used herein, “retail store” and “third party vendor” includes traditional “brick and mortar” retail stores, as well as internet retailers, or “e-tailers.” Also as used herein, the terms “electronic device” and “device” are used interchangeably, and include, but are not limited to, devices such as cell phones, personal digital assistants (such as Treo® devices, Palm® devices and Blackberry® devices), MP3 players (such as IPod® devices), media devices (such as I-Phone® devices), toys (such as Wii®, Playstation® and X-Box® gaming platforms), and other types of electronic devices (such as computers and DVD players).

At the time of purchasing an electronic device, consumers may be presented with the option of purchasing an extended warranty for the device. The cost of an extended warranty may be significant relative to the cost of the device. Due to the relatively high cost, many consumers fail to purchase such extended warranties. In addition, many original and extended warranty plans fail to cover certain items that may be prone to breakage, such as LCD screens. In some instances, original and extended warranties may be considered void by the manufacturer if a consumer performs a relatively simple repair, such as replacing a battery.

Because resellers do not warrant the devices that they sell, consumers cannot return the devices to the reseller. Instead, they must return the device to the manufacturer for the repair. It is often difficult and time-consuming for consumers to obtain repair information from the manufacturer, and the procedures for repair vary among manufacturers. For example, certain manufacturers may require consumers to return the device to a sponsored repair facility, while others may require consumers to send the device to a third party for repair. Regardless of the manufacturer's method of repair, the consumer often bears the cost of shipping the device to and from the repair facility, and is often faced with uncertainty as to the length of time to make the repair, if it can be repaired. If the device can be repaired, then consumers are faced with the uncertainty of whether the repair is covered by the warranty.

Rather than dealing with the foregoing uncertainties, many consumers prefer to purchase new devices, even though replacing a defective device may be more costly than its repair.

### SUMMARY

The present disclosure is directed, in one embodiment, to a method comprising providing a vendor with a repair kit for a selected electronic device, the repair kit comprising a code corresponding to the kit; receiving a request from a consumer for a coded shipping label for the selected electronic device; providing the consumer with the coded shipping label in response to the request; receiving the selected electronic device from the consumer; repairing the selected electronic device; and returning the selected electronic device to the consumer.

In another embodiment, the disclosure is directed to a kit for repairing an electronic device, comprising an activation code corresponding to the kit, for entry into a repair vendor's order system; a printed instruction sheet for activating the code for obtaining a pre-paid shipping label for shipping the electronic device from the consumer to the repair vendor.

In yet another embodiment, the disclosure is directed to a repair kit for repairing an electronic device, comprising an activation code corresponding to the kit, for entry into a repair vendor's order system; a shipping box for shipping the electronic device to the repair vendor; and a printed instruction sheet for activating the code for obtaining a pre-paid shipping label for shipping the electronic device from the consumer to the repair vendor.

### BRIEF DESCRIPTION OF THE DRAWINGS

Referring now to the figures, which are exemplary embodiments, and wherein like elements are numbered alike:

FIGS. 1 and 2 illustrate exemplary embodiments of repair kits according to the present disclosure;

FIG. 3 illustrates the contents of the repair kits shown in FIGS. 1 and 2;

FIG. 4 is a copy of a printout from a repair vendor's web page, showing the instructions for creating an order, printing a shipping label, and packing and shipping an electronic device to be repaired;

FIG. 5 is a copy of a printout from a repair vendor's web page, showing the instructions for creating an order, printing a shipping label, and obtaining packing materials for an electronic device to be repaired; and

FIG. 6 is an illustrative flow chart describing the method according to the present disclosure.

### DETAILED DESCRIPTION OF EXEMPLARY EMBODIMENTS

The present disclosure is directed to a method of obtaining a repair for an electronic device from a repair vendor, and electronic device repair kits for use with the method. Use of the method and kits provides consumers with the ability to purchase repair services for a selected electronic device for a predetermined flat fee and to have the repaired device returned in a relatively short time-frame.

As an initial matter, unless otherwise defined, technical and scientific terms used herein have the same meaning as is commonly understood by one of skill in the art to which this disclosure belongs. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items.

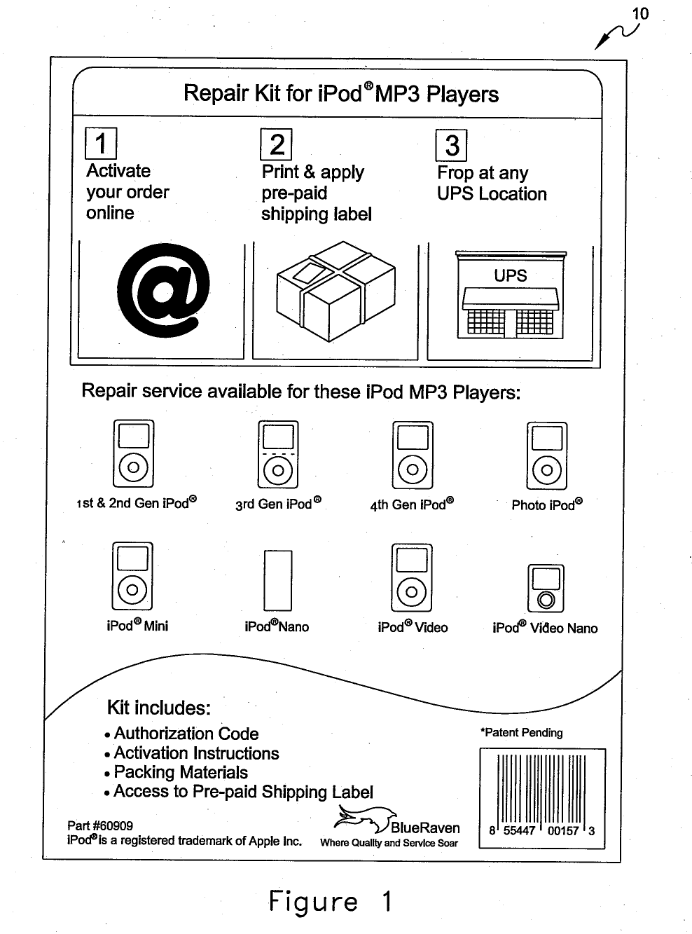

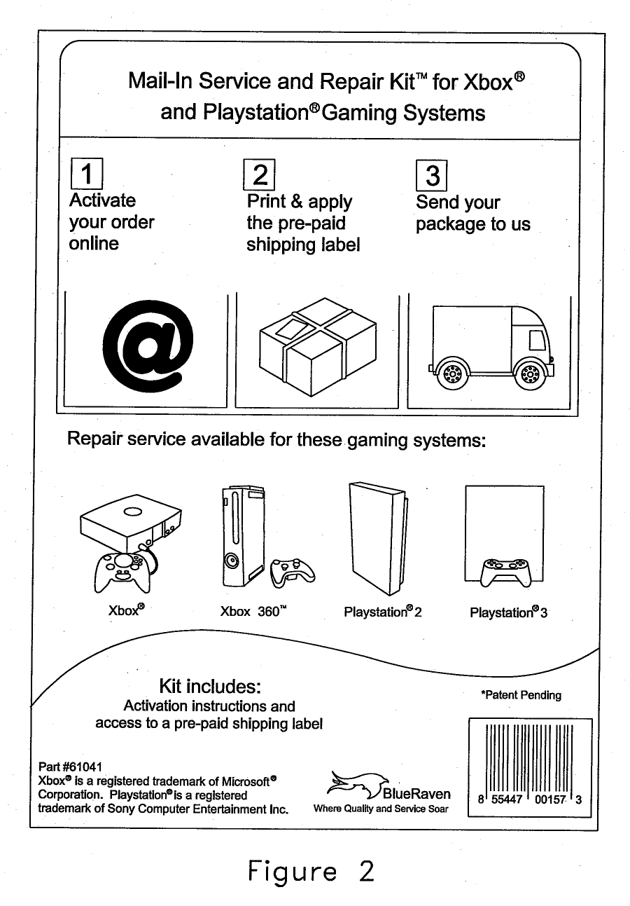

FIGS. 1 and 2, when taken together, show one exemplary embodiment of a service repair kit 10 (hereinafter “kit”) according to the present disclosure. Kit 10 is adapted for the repair of a selected device, which allows the consumer to select a kit corresponding to the type of device that they would like to be repaired. For example, kit 10 may be labeled to inform the consumer that the kit is adapted for the repair of a particular type of electronic device such as an IPod Video® MP3 device. It should be understood that kits may in some instances be adapted for one or more of several types of electronic devices, all of which would be included on the kit label in order to allow the consumer to select the appropriate kit.

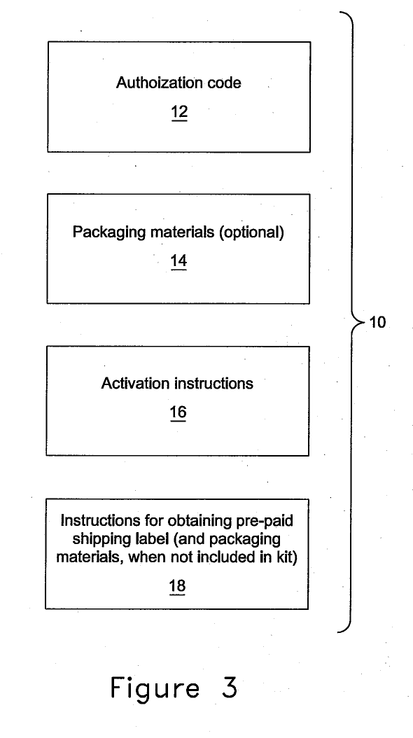

Each kit 10 contains an authorization code 12 (hereinafter “code”), various optional packaging materials 14, printed activation instructions 16, and printed instructions for obtaining a pre-paid, coded shipping label 18 and/or packaging materials 14. FIG. 3 shows a label for a repair kit 10 that does not include optional packaging materials 14. The printed activation instructions 16 and instructions for obtaining the pre-paid shipping label may be on separate sheets or together on a single sheet, and all or portions thereof may be printed from the repair vendor's website.

The code 12 allows the repair vendor to validate or verify that the transaction is legitimate.

The materials 14 for properly packaging the device can comprise, for example, wrapping materials for safeguarding the device from damage resulting from static, vibration, impact, and the like, as well as a suitable container for shipping the device. Examples of such materials comprise wrapping and/or packaging materials with anti-static properties, impact-absorption properties, vibration-dampening properties, and the like, as well as combinations of the foregoing. Examples of suitable shipping containers can comprise cardboard boxes, plastic containers, TYVEK® shipping envelopes, and the like.

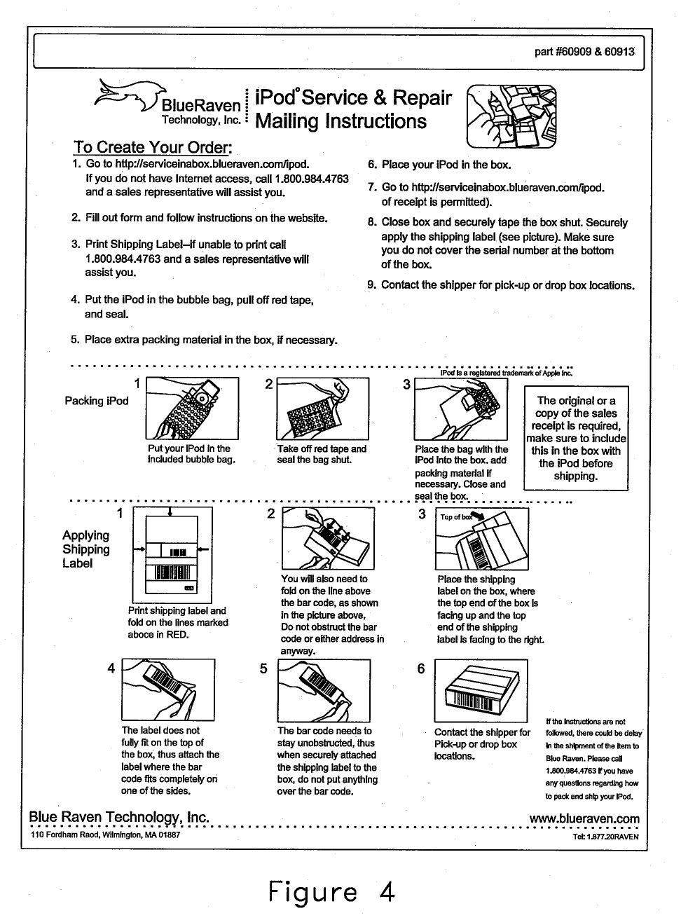

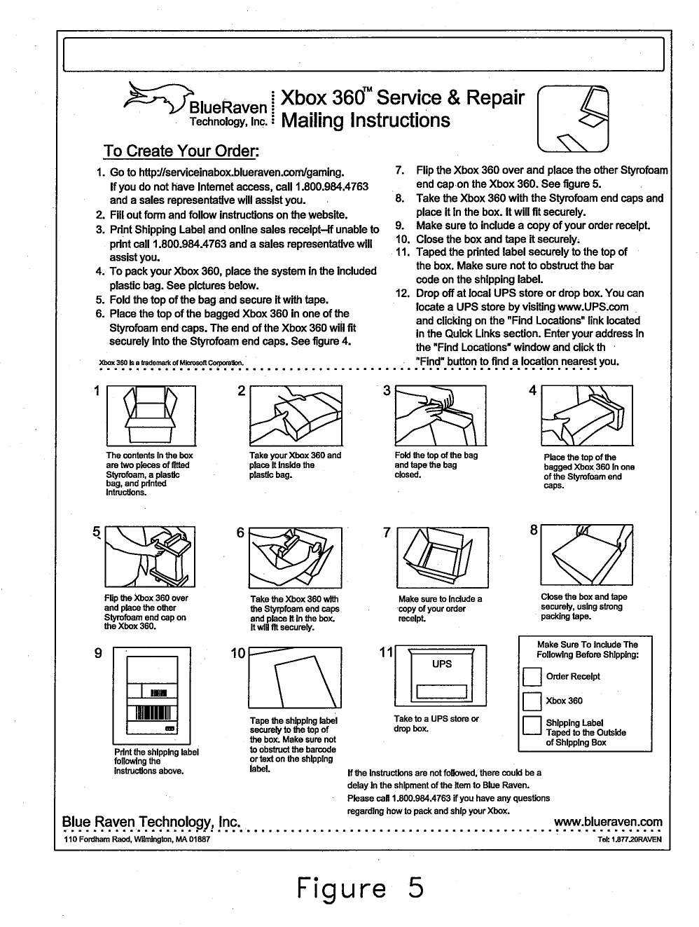

The activation instructions 16 direct the consumer to a specific web page at the website of the repair vendor. The web page contains instructions for the consumer to create an order with the repair vendor, and to package and ship the device to the repair vendor for repair. Further instructions 18 are included for obtaining the pre-paid coded shipping label (not illustrated). FIGS. 4 and 5 shows an exemplary web page of a repair vendor containing the foregoing instructions.

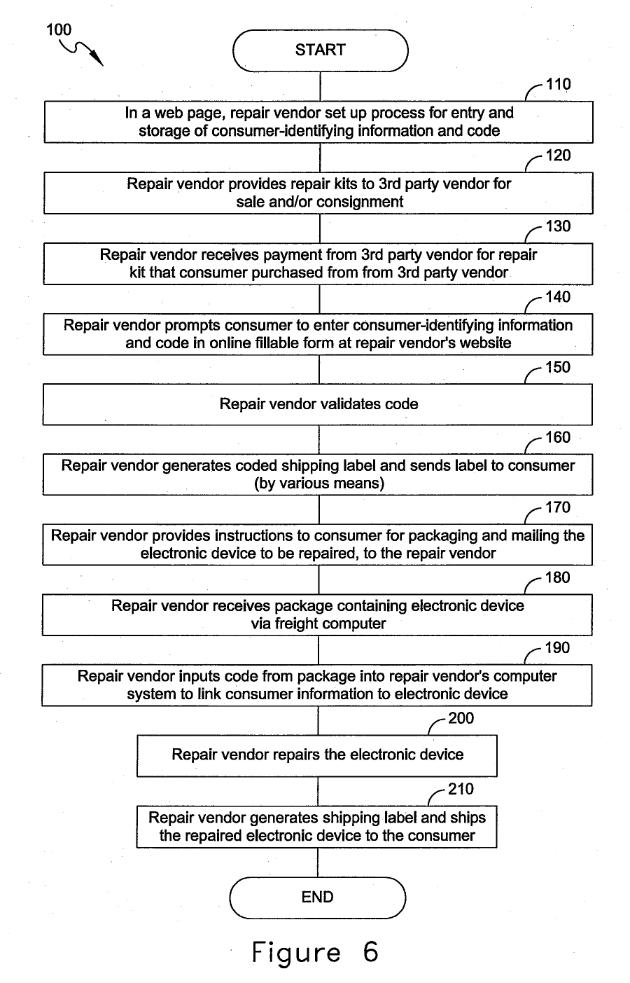

The kits facilitate a method 100 for obtaining the repair of a selected electronic device, from a repair vendor. As shown in FIG. 6, method 100 involves a repair vendor setting up a web page on its website for entry of the code and for entry and storage of consumer-identifying information (step 110). The method also involves the repair vendor providing coded repair kits to a third party vendor (hereinafter “3^{rd} party vendor”) for sale, consignment, or both (step 120). Examples of 3^{rd} party vendors include, but are not limited to, electronic stores, home improvement centers, and the like.

A consumer can then select and purchase a kit from the 3rd party vendor (step 130). The purchase price of the kit includes the cost of repairing the device, the cost of shipping the device from the consumer to the repair vendor, and the cost of shipping the device from the repair vendor back to the consumer. As a result, the consumer knows in advance the total cost of the repair and shipping charges, which facilitates the decision to repair or replace a defective electronic device.

Rather than paying the repair vendor for the repair kit, the consumer pays the 3^{rd} party vendor (step 140), and the 3^{rd} party vendor pays the repair vendor, as will be discussed in greater detail below.

The activation instructions 16 from the repair vendor that are contained in the kit direct the consumer to a specific web page on the repair vendor's website. The repair vendor website contains an online fillable form into which the consumer is directed to enter information related to, for example, the type of electronic device to be repaired, a description of the problem with the electronic device, as well as consumer identifying information, such as a return address to which the repaired device can be mailed by the repair vendor, and the authorization code (step 140). After entering the foregoing information, instructions from the repair vendor prompt the consumer to “submit” its service request.

Upon electronic receipt of the service request, the repair vendor validates the service request (step 150), and also sends the consumer an automated email indicating that the service request is being validated. Upon validation, the repair vendor generates an order number, which is a unique identifier for tracking the progress and status of the device during the repair cycle.

The repair vendor then generates the pre-paid shipping label, which can comprise, for example, a code that relates the package to the order information (step 160). Any type of code can be used to relate the package to the order, one exemplary type being a bar code containing encoded information that can be scanned by the repair vendor. The repair vendor then provides the consumer with the label (step 170). The repair vendor can provide the label to the consumer in a variety of ways, for example, by posting the label to its website for printing by the consumer, by email, facsimile or regular mail.

Alternatively, the consumer can contact the repair vendor to request an alternative method for receiving the shipping label from the repair vendor. Thus, obtaining the shipping label can involve the consumer contacting the repair vendor (for example, by telephone or email) and requesting that the repair vendor send a completed shipping label to the consumer. The repair vendor then can obtain the information related to the type of electronic device to be repaired, a description of the problem with the device, the consumer identifying information, and thereafter the repair vendor can generate the shipping label. The shipping label then can be delivered to the consumer in a variety of ways such as, for example, by email, by regular mail, and like. However, it should be understood that it is desirable to use the fastest method of delivering the shipping label to the consumer in order to expedite the repair process.

Before, after or simultaneously with obtaining the shipping label, the consumer or an individual assisting the consumer can properly package the device using the materials found in the kit. Properly packaging the device can involve, for example, wrapping the device in materials that safeguard the device from damage from static, vibration, impact, and the like. After wrapping the device in such safeguarding materials, the consumer can insert the wrapped device in the shipping container contained in the kit.

After properly packaging the device, the consumer can apply the pre-paid shipping label to the package, and then can ship the packaged device to the repair vendor using the instructions provided in the kit. The method of shipment can be selected by and pre-paid by the repair vendor, and the packaged device can be shipped using the shipping method specified on the shipping label. A variety of shipping services can be used by the repair vendor such as, for example, overnight mail, ground service, and the like, but it should be understood that it is desirable to use the fastest shipping method.

Shortly thereafter, the repair vendor receives the packaged electronic device from the consumer (step 180). Upon receipt, the repair vendor can refer to the code on the shipping label in order to access the existing order information (step 190). For example, if the code is a bar code, the repair code can be scanned by the repair vendor in order to retrieve the order information. Use of such codes improves the repair vendor's efficiency and prevents inadvertent errors.

Upon receipt of the packaged device through the selected shipping method, the repair vendor can obtain the consumer-identifying information and code by, for example, scanning the bar code on the shipping label.

After obtaining the order information, the repair vendor repairs the electronic device, if can be repaired (step 200). During the repair process, the repair vendor can continue to track the status of the device.

After completing the repair, the repair vendor generates a return shipping label using the information provided by the consumer, and ships the repaired device to the consumer, again by selecting one of the shipping methods noted above (step 220). The consumer receives the repaired device shortly thereafter (step 230).

At any desirable time during the foregoing method, the repair vendor can generate an invoice directed to the 3rd party vendor, from whom the repair vendor can obtain payment, rather than directly from the consumer. Thus, for example, the repair vendor can generate the invoice before, after or simultaneously with selling and/or consigning the repair kits, or before, after or simultaneously with performing the repair on an electronic device received by the repair vendor. The identification of the 3rd party vendor can be obtained by the repair vendor from the information entered by the consumer at the time of creating the order, or from a copy of the purchase receipt that the consumer may be requested to include in the shipping container. Alternatively, if the 3rd party vendor had purchased the kits directly from the repair vendor, the transaction may be considered complete.

Another exemplary embodiment is directed to an electronic device service card (hereinafter “card,” not illustrated) according to the present disclosure. Each card can comprise a unique serial number that is covered by a removable material or label, and written instructions for obtaining a repair kit from the repair vendor. The card can be any size, but it is desirable that it should be relatively small (e.g., a 2″×3.5″ plastic card) so that it can be displayed on, for example, a peg-board type of display. Because the card requires far less shelf space that the kits described above, it may be desirable in situations in which retailers have limited shelf space and/or square footage, for example, convenience stores, drug store chains, mall kiosks, high traffic retailers, and the like. The cards also may be desirable for repairing relatively large electronic devices that require larger packaging than, for example, media players, and the like. Examples of the foregoing include, but are not limited to, notebooks, gaming stations and other high end electronics.

According to the method, the cards can be purchased directly from or consigned by the repair vendor. Once sold or consigned, the unique serial number can be scanned and logged into the repair vendor's CRM system. Thereafter, the serial number can be removed prior to shipment, providing the repair vendor with a history of cards that have been sold to each 3rd party vendor.

After purchasing a card, the consumer can remove the removable material or label to reveal the unique serial number, which can be used to validate proof of purchase. The covered serial number is the same serial number that was initially scanned and removed from the card at the time of shipment from the repair vendor to the 3rd party vendor.

As noted above, the card includes the same instructions described above with respect to the previous embodiment. At the repair vendor's website, the consumer can enter consumer identifying information (as described above) and the serial number printed on the card.

After receipt of the consumer-identifying information and serial number, the repair vendor can validate the consumer's “hidden” serial number by cross-referencing it with the serial number that was scanned and removed prior to shipment of the cards to the 3rd party vendor, which ensures that the card was actually purchased (i.e., as a theft prevention measure), and also validates the 3rd party vendor that sold the card.

After the repair vendor has validated the serial number, an order number is assigned and returned to the consumer by, for example, an email communication. Thereafter, packaging materials 14 (e.g., a shipping box and packing material) can be sent to the consumer by the repair vendor, and the consumer can follow the same instructions as described above with respect to the electronic device repair kit.

According to any of the foregoing embodiments, the consumer can track the repair progress by logging on to the repair vendor's website and entering the assigned order number. Alternatively or in addition, the consumer can contact the repair vendor call center to get answers to any questions unavailable on the website.

As with the kits, the repair vendor can generate an invoice directed to the 3rd party vendor, from whom the repair vendor can obtain payment, rather than directly from the consumer, before, after or simultaneously with performing the repair on an electronic device. The identification of the 3rd party vendor can be obtained by the repair vendor from the information entered by the consumer at the time of creating the order, or from a copy of the purchase receipt that the consumer may be requested to include in the shipping container. Alternatively, if the 3rd party vendor had purchased the cards directly from the repair vendor, the transaction is complete. If the cards were consigned by the repair vendor to the 3rd party vendor, the repair vendor can invoice the consumer providing the serial number validation as proof that the unit was received and repaired.

Advantages of the present repair kits and methods include, but are not limited to: 1) providing consumers with a predetermined cost for repairing an electronic device; 2) providing consumers with a predetermined time-frame for repairing an electronic device; 3) providing consumers with a convenient method for having a device repaired by bypassing sometimes complicated, expensive and lengthy repairs by the manufacturer or its representatives; and 4) providing consumers with the ability to track their repairs.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method, comprising:
providing a vendor with a repair kit for a selected electronic device, the repair kit comprising a code corresponding to the kit;
receiving a request from a consumer for a coded shipping label for the selected electronic device;
providing the consumer with the coded shipping label in response to the request;
receiving the selected electronic device from the consumer;
repairing the selected electronic device; and
returning the selected electronic device to the consumer.

2. The method of claim 1, further comprising receiving payment for the repair kit from the vendor.

3. The method of claim 2, wherein receiving payment for the repair kit from the vendor takes places simultaneously with providing a vendor with the repair kit.

4. The method of claim 2, wherein receiving payment for the repair kit from the vendor takes places after repairing the selected electronic device.

5. The method of claim 1, wherein the repair kit comprises packing material.

6. The method of claim 5, wherein the packing material comprises a shipping box.

7. A kit for repairing an electronic device, comprising:
an activation code corresponding to the kit, for entry into a repair vendor's order system;
a printed instruction sheet for activating the code for obtaining a pre-paid shipping label for shipping the electronic device from the consumer to the repair vendor.

8. The kit of claim 7, further comprising packing material for shipping the electronic device to the repair vendor.

9. The kit of claim 8, wherein the packing material comprises a shipping box.

10. A repair kit for repairing an electronic device, comprising:
an activation code corresponding to the kit, for entry into a repair vendor's order system;
a shipping box for shipping the electronic device to the repair vendor; and
a printed instruction sheet for activating the code for obtaining a pre-paid shipping label for shipping the electronic device from the consumer to the repair vendor.
